(19) United States
(12) Patent Application Publication
(10) Pub. No.: US 2015/0201478 A1
(43) Pub. Date: Jul. 16, 2015

(54) HEADLIGHT ARRANGEMENT FOR A MOTOR VEHICLE

(71) Applicant: GM GLOBAL TECHNOLOGY OPERATIONS LLC, Detroit, MI (US)

(72) Inventor: Marten WITTORF, Ingelheim (DE)

(73) Assignee: GM GLOBAL TECHNOLOGY OPERATIONS LLC, Detroit, MI (US)

(21) Appl. No.: 14/097,730

(22) Filed: Dec. 5, 2013

(30) Foreign Application Priority Data
Dec. 5, 2012 (DE) 10 2012 023 786.3

(51) Int. Cl. H05B 33/08; B60Q 1/14; B60Q 1/20

(52) U.S. Cl. CPC H05B 33/0854; B60Q 1/20; B60Q 1/1423

(57) ABSTRACT

A headlight arrangement is provided for a motor vehicle, with a light source configured as a light-emitting diode (LED) and with a control device coupled therewith, which is configured for generating an operating signal for operating the light source, and the frequency of the operating signal can be regulated at least as a function of a momentary operating state of the vehicle or as a function of a vehicle environment.

### CROSS-REFERENCE TO RELATED APPLICATION

This application claims priority to German Patent Application No. 10 2012 023 786.3, filed Dec. 5, 2012, which is incorporated herein by reference in its entirety.

### TECHNICAL FIELD

The technical field relates to a headlight arrangement for a motor vehicle with at least one light source configured as a light-emitting Diode (LED).

### BACKGROUND

LED light sources are used increasingly in the automotive field. In particular additional functions such as a flashing light and a brake light are increasingly implemented using LED technology. Furthermore headlights are known, in which the dipped headlight is based on LED technology. Also, concepts currently exist for full-LED-headlights which comprise a plurality of individual LED light sources which can be adaptively and variably configured, such as for the optional implementation of undimmed headlights and dimmed headlights.

Such LED headlights, albeit, have a high degree of efficiency compared to conventional gas-discharge or incandescent lights. However, if there is a demand for a comparatively high light output and brightness of the headlight, the necessary electric energy must of course be provided in the motor vehicle. In particular with electrically driven motor vehicles, the electric energy consumption or power consumption of such LED headlights may impinge on motor vehicle running time.

The DE 10 2009 024 352 A1 has already disclosed a method for controlling the output of the illuminating device for a motor vehicle, with the aid of which the output of a dipped headlight during driving can be distinctly reduced whilst driving through a built-up area. Accordingly it is possible to adapt the light current provided by the headlight to the driver's actual dipped headlight requirements as a function of the driving situation, and in particular to reduce the output of the dipped headlight accordingly, as the vehicle speed decreases.

A reduction in output of the headlight, as a consequence of which a noticeable reduction in light output or brightness of the headlight occurs, must, however, be regarded as critical for reasons of traffic safety. Furthermore, if individual LED arrangements are individually connected or disconnected, the size or width of the field of vision, which can be lit by the respective headlight, may be reduced so that objects which might suddenly emerge from the darkness cannot be sufficiently illuminated and may even be recognized too late by the driver of the motor vehicle.

In view of the foregoing, it is at least one object to optimized headlight arrangement for a motor vehicle as regards its energy consumption, which despite a reduced energy consumption provides a comparatively high light output and which has almost no effect or only a very small detrimental effect upon the perceptiveness of the driver or other traffic participants in the environment of the motor vehicle. In addition, other objects, desirable features and characteristics will become apparent from the subsequent summary and detailed description, and the appended claims, taken in conjunction with the accompanying drawings and this background.

### SUMMARY

Accordingly, there is provided a headlight arrangement for a motor vehicle. The headlight arrangement comprises at least one light source configured as a light-emitting diode (LED). The headlight arrangement further comprises a control device coupled with the light source, which is configured for generating an operating signal pulsed over time for operating the light source. The at least one LED light source can therefore be operated in a pulsed mode via the control device. The frequency of the operating signal of the light source can be regulated at least as a function of a momentary operating state of the motor vehicle or as a function of an environmental parameter of the motor vehicle.

The frequency of the operating signal is reduced in comparison to conventional operating modes of LED light sources, in order to advantageously reduce the power and energy consumption averaged over time, of the LED light source. In particular by reducing the frequency of the operating signal, it is possible for the periodic operating signal not to comprise a maximum amplitude of operating current or operating voltage over a complete period duration, but for the operating signal to comprise an amplitude of approximately zero for a time period of at least approximately 10%, 20%, 30%, 40%, 50%, 60%, 70%, 80% or even 90%. As a consequence the pulse duration or the pulse length over time of the operating signal can be accordingly variably reduced with respect to the period duration.

With respect to a period duration this makes it possible for the LED light source to supply a sufficient voltage or a sufficient operating current for the operation of the LED light source for only approximately 10% of a period duration of its periodic operating signal, i.e., for the signal to be pulsed for only that amount of time. The pulsed operating signal which can be generated by the control device may for example be configured in the form of a square-wave signal and may comprise individual operating pulses, in which the LED light source is stimulated exclusively for emitting light. For the time period between consecutive operating signal pulses, however, the LED light source is, so to speak, switched off.

Because the frequency of the pulsed operating signal is regulated as a function of the operating state of the vehicle or as a function of an environmental parameter of the vehicle, it is possible, despite the pulsed and intermittently (so-to-speak) switched-off operating signal, to operate the LED light source in such a way as to be substantially flicker-free to the observer. This permits the frequency of the operating signal to be set to above that frequency which is the threshold at which the human eye begins to detect flickering or glimmer.

In such frequency ranges the human eye only registers an averaged-over-time intensity of the light emitted by the light source. Here the light intensity can be regulated largely independently of the frequency of the operating signal. In particular, the intensity of the headlight arrangement can be regulated by the pulse ratio of the pulsed operating signal, i.e., by the pulse width over time, and thus by the ratio of the time portions of the operating signal in the switched-on state of the light source.

According to an embodiment the frequency of the operating signal can be set, at least at certain times, within the range of the so-called flicker fusion frequency of the human eye. The flicker fusion frequency is that frequency at which a sequence of light flashes is perceived by the human eye as a continuous light. The light does not flicker until a so-called incomplete fusion. The flicker fusion frequency lies typically between approximately 10 Hz and approximately 80 Hz.

The flicker fusion frequency depends on the strength of the light stimuli, the adaption state of the retina and the general activation level of the respective person. The flicker fusion frequency is further dependent on the size of the illuminated retina area, the luminance and the wavelength of the received light. The flicker fusion frequency is also dependent on the light intensity. For light intensities in the range of scotopic vision it lies between approximately 20 Hz and approximately 25 Hz. For higher light intensities which permit photopic vision the flicker fusion frequency increases with the logarithm of light intensity and in dependence of the area distribution of the light intensity to up to approximately 80 Hz.

Accordingly the control device is configured for adapting the frequency of the operating signal to a flicker fusion frequency typically corresponding to one of the external conditions. The external conditions may depend upon such factors as spectral distribution, the luminance or the spatial propagation characteristic of the light emitted by the LED light source or may be correlated therewith, may accordingly be determined by the control device and lastly be used for regulating the frequency of the operating signal.

In a further embodiment provision is made, in particular, for the frequency of the operating signal to be set to an operating frequency that is approximately 1%, 5%, 10%, 20%, 50% or 100% higher than the flicker fusion frequency. By setting the operating frequency to specified ranges above an assumed, calculated or estimated flicker fusion frequency, it is possible for an observer to perceive the light emitted by the LED light source as a continuous light.

According to a further embodiment provision may be made for the frequency of the operating signal to be set to an operating frequency, which is lower by approximately 1%, 5%, 10%, 20% or 50% than the flicker fusion frequency. With operating frequencies of this kind an at least subconscious perception of flickering of the LED light source is deliberately accepted. Operation of the light source within the range of the flicker fusion frequency or slightly below it can heighten the perceptibility of the human eye/human image processing in an advantageous manner

Generally speaking an at least slightly unsteady or flickering light or a light starting to flicker is recognized much earlier by the observer than a constantly even light emission. An at least slightly but intentional flickering of the LED light source may cause a luminous stimulus which is quite unpleasant for the observer, and which inherently issues a warning function and attracts the attention of the observing person.

According to a further embodiment the frequency of the operating signal can be controlled to drive the at least one LED light source between approximately 15 Hz and 90 Hz. The tunable and possibly continuous control of the operating frequency in the range between approximately 15 Hz and 90 Hz also permits different operating modes of the at least one LED light source. As such at approximately 15 Hz it is feasible that the light source will blink in rapid succession, which quite sharply attracts the attention of other traffic participants. In higher frequency ranges however, say above approximately 70 Hz to as far as approximately 90 Hz, the energy consumption as well as the heat generation of the at least one LED light source can be reduced in an advantageous manner, without impairing the brightness or light intensity as perceived by the observer.

According to a further embodiment provision is made for the frequency of the operating signal to be set as a function of the brightness of the vehicle environment. In addition the frequency of the operating signal can also be set as a function of the light intensity of the light source averaged over time. Since the flicker fusion frequency is particularly intensity-dependent, the operating frequency can be variably adapted to a flicker fusion frequency corresponding to the prevailing light conditions by regulating the operating signal frequency as a function of the brightness of the vehicle environment and as a function of the intensity of the light emitted by the light source.

According to a further embodiment provision is made for the frequency of the operating signal to be controllable as a function of a vehicle speed. The vehicle speed can be used in particular for drawing conclusions as to whether the vehicle is travelling across country, on the motorway or in urban areas. Due to a speed-dependent control of the operating frequency of the at least one LED light source the intensity averaged over time, of the light emitted by the at least one light source can be adaptively adjusted to the vehicle speed. Thus in particular in the medium-to-lower speed range it is feasible, in principle, to minimize the light output of the headlight arrangement by reducing the operating frequency of the light source. The energy consumption as well as the heat generation of the light source can thus be reduced according to the situation.

According to a further embodiments provision is made for the frequency of the operating signal for the LED light source to be controlled as a function of the energy reserves available to the vehicle. This is of advantage in particular for electric vehicles with an electric energy store. As such, by controlling the frequency of the operating signal of the LED light source the power and energy consumption of the light source can be reduced which can be of advantage in particular when the energy reserves of the motor vehicle are dwindling. Insofar the range of the motor vehicle can be advantageously extended as needed by a reduced energy consumption of the headlight arrangement.

According to a further embodiment, provision is made, in particular, for the control device of the headlight arrangement to be configured for controlling the at least one light source in a pulse-width-modulated manner. Insofar the control device is configured, in particular, for generating periodic square-wave pulses. The percentage proportion of the pulse duration or pulse width can be modified in relation to the period duration for regulating the light intensity, including for independently or additionally regulating the repetition frequency of the operating signal.

For reducing the power consumption of the light source provision is made in particular for setting comparatively short pulse widths, whilst for a maximum light yield the time length of consecutive pulses can be correspondingly stretched over time. Due to the envisaged provision of reducing the repetition frequency of individual pulses, the number of pulses per time unit and thus the overall energy consumption of the light source can be reduced in an advantageous manner without this frequency shift becoming noticeable in the form of flickering.

According to a further embodiment provision is further made for the headlight arrangement to comprise a plurality of LED light sources. Individual LED light sources may be subjected to different operating signals either in pairs or groups or also independently of one another. Furthermore the LED light sources may comprise several color light sources such as red, green and blue LED light sources so that by subjecting individual color LEDs to different signals, different spectrum colors can be generated.

The headlight arrangement can be configured almost at random as a front headlight, a fog headlight, a daytime running light, a dipped-beam headlight, a full-beam headlight, a flashing light, a cornering light or even a rear light, a brake light, a reversing light or a rear fog light. It is also feasible that the headlight arrangement is configured as a full-beam LED headlight, in which all functions of the previously described lights or illuminants are combined in one headlight module.

According to a further embodiment, a motor vehicle is provided, which at least comprises a previously described headlight arrangement, and a method is provided for operating a headlight arrangement. The headlight arrangement comprises at least one light source configured as a light-emitting diode (LED). In a first step the method ascertains a momentary operating state of the vehicle. In a second step an operating signal pulsed over time is generated for operating the light source, and in a third step finally the signal is regulated as a function of the ascertained operating state of the motor vehicle with regard to its frequency.

In general the method can be implemented with the previously described headlight arrangement. Insofar all features and advantages described in relation to the previously described headlight arrangement also apply in the same way to the method for operating the headlight arrangement.

According to an embodiment of the method provision is made, in particular for the frequency of the operating signal, for the at least one LED light source to be set at least sometimes within the range of the flicker fusion frequency of the human eye. In addition, according to a further embodiment, a computer program product is provided for operating a previously described headlight arrangement. The headlight arrangement comprises at least one light source configured as a light-emitting diode (LED). The computer program product comprises program means for ascertaining a momentary operating state of the vehicle. It also comprises program means for generating an operating signal pulsed over time for operating the light source as well as program means for regulating the frequency of the operating signal as a function of the ascertained operating state.

The computer program product is configured, in particular for operating the previously described headlight arrangement and is provided for this. Insofar all advantages and features described with reference to the headlight arrangement also apply in the same way to the computer program product; and vice-versa.

According to a further embodiment, a device is provided for operating a previously described headlight arrangement. The headlight arrangement comprises at least one light source configured as a light-emitting diode (LED). The device comprises an ascertaining device for ascertaining a momentary operating state of the vehicle as well as a generating device for generating an operating signal pulsed over time for operating the light source and regulating device for regulating the frequency of the operating signal as a function of the ascertained operating state. Here too all previously described features and advantages of the headlight arrangement apply in the same way for the device for operating the same; and vice-versa.

### BRIEF DESCRIPTION OF THE DRAWINGS

The present invention will hereinafter be described in conjunction with the following drawing figures, wherein like numerals denote like elements, and:

FIG. 1 shows a schematic side view of a motor vehicle with a headlight arrangement;

FIG. 2 shows a block diagram of the headlight arrangement;

FIG. 3 shows a frequency diagram for depicting different operating frequencies of the headlight arrangement; and

FIG. 4 shows a flow diagram of the method for operating the headlight arrangement.

### DETAILED DESCRIPTION

The following detailed description is merely exemplary in nature and is not intended to limit application and uses. Furthermore, there is no intention to be bound by any theory presented in the preceding background or summary or the following detailed description.

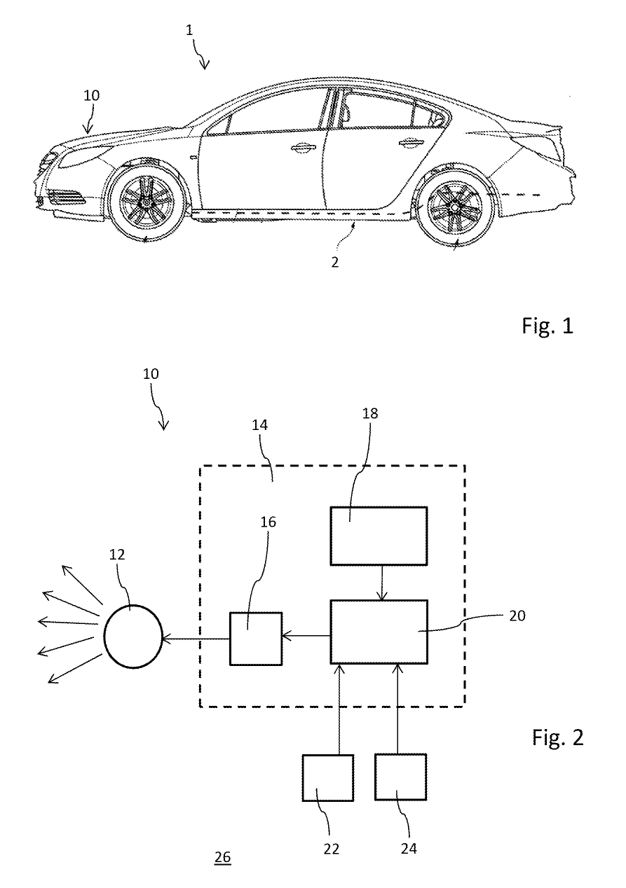

The motor vehicle 1 shown in FIG. 1 configured as a private car comprises a motor vehicle body 2, at the front of which is provided a headlight arrangement 10 configured as a front headlight. The headlight arrangement 10 as shown in FIG. 2 in a block diagram comprises at least one LED light source 12 for the emission of light. The LED light source 12 is coupled with a control device 14, which comprises a driver module 16 for the LED light source 12 and a control unit 20, in particular for regulating the pulse widths as well as the pulse frequencies of an operating signal.

The operating signal, with which the LED light source 12 is ultimately operated, can be generated by the driver module 16, which is preferably configured for generating pulse-width-modulated operating signals. The control unit 20 may for example be configured as a microcontroller or a comparable computer unit. The control device 14 may further comprise an input unit 18 by which either the end user himself or other components of the motor vehicle or the motor vehicle electronics can selectively influence the control unit 20 and thus also the generation of the operating signals for the light source 12.

The illustration of a control device 14 with a control unit 20 and a driver module 16 is merely exemplary. Alternatively the functions of the driver module 16 and of the control unit 20 may be housed in a single constructional unit and be integrated with it. The control device 14, and therefore its control unit 20 is also coupled with two sensors 22, 24. The sensor 22, for example, may be configured as a speed sensor and can forward speed information of the motor vehicle to the control unit 20. Corresponding to the vehicle speed measured or provided by the inboard electronics of the motor vehicle in other ways, the control unit 20 together with the driver module 16 may selectively change the frequency of the operating signal as well as the pulse width of the operating signal.

The other sensor 24 may, for example, be configured as a brightness sensor and thus contribute to determining the brightness of the vehicle environment. The brightness sensor 24 as well as the speed sensor 22 may both be coupled with further components of the vehicle electronics in order to automatically set the general operating mode of the headlight arrangement as a function of the brightness of the vehicle environment 26 between daytime running light and dipped headlight.

Insofar the illustration of the two sensors 22, 24 is predominantly purely exemplary. The sensors 22, 24 may be connected almost ad lib with the motor vehicle electronics. Their signals can be exchanged between several signal-processing modules or control devices via a communication bus such as a CAN bus or comparable onboard communication systems.

The control unit 20 together with the driver module 16 is configured, in particular, to set the frequency of the operating signal for the LED light source 12 within the range of a flicker fusion frequency of the human eye. Depending upon the operating state of the motor vehicle 1 or a corresponding driving situation, provision may also be made to set the operating frequency of the operating signals to values above the flicker fusion frequency. The pulse width of the operating signal may be modulated independently of the frequency thereof in order to in particular regulate the intensity of the light emitted by the LED light source 12 according to demand.

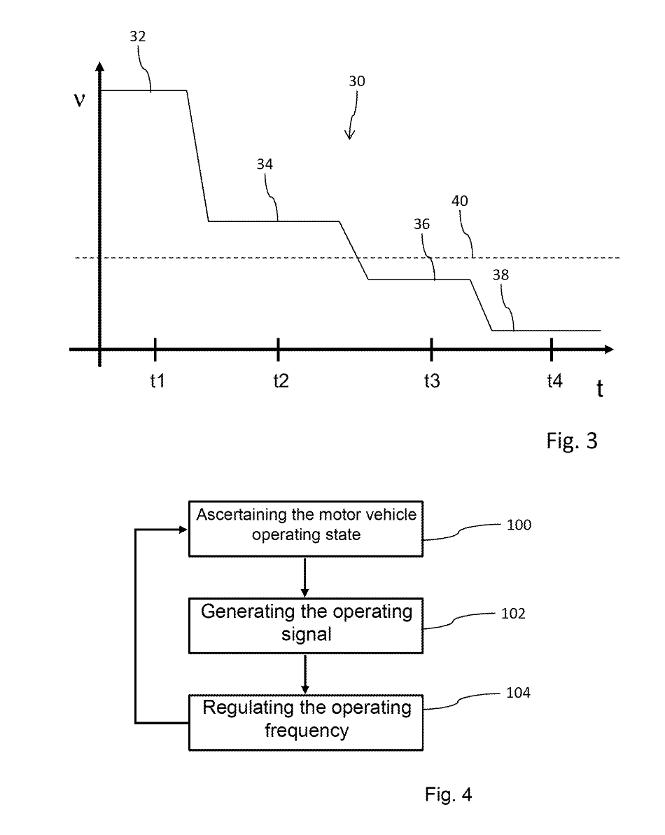

The diagram 30 of FIG. 3 shows the flicker fusion frequency 40 in the form of a broken horizontal line. Also shown in the diagram 30 is the frequency of the operating signal over a random time progression. To begin with, i.e., at a time t1, the headlight arrangement is operated by an operating signal 32 of maximum frequency. An operating state of this kind may be required and desired for drives at high speed.

At a point in time t2 however, due to an altered operating state of the motor vehicle 1, such a high light output may under certain circumstances be no longer necessary. Therefore the frequency of the operating signal 34 may be noticeably reduced in comparison to the frequency of the operating signal 32. However, the frequency of the operating signal 34 is still distinctly above the flicker fusion frequency 40.

Although the LED light source 12, at a time t2, is operated at a lower operating frequency, this is not yet perceived by the observer as a flickering of the light source 12. Only at a later time t4, when the operating signal 36 comprises an operating frequency which is below the flicker fusion frequency 40, the observer may become aware of a flickering effect.

Under certain operating circumstances such as during braking of the motor vehicle 1 a flickering display of this kind may prove to be advantageous for a better perception of the headlight arrangement 10. At a point in time t4 finally a further reduced frequency may be present, such as in the range of approximately 15 Hz or below, so that the headlight arrangement 10 is then indeed perceived by an external observer as a flashing light source. Such an operating mode may be of advantage in particular for a switched-off motor or for a stationary motor vehicle 1.

In FIG. 4 finally a flow diagram of the method for operating a headlight arrangement 10 is shown. In a first step 100 at least one operating state of the motor vehicle 1 or at least one environmental parameter of the motor vehicle 1 is ascertained. In the following step 102 a pulsed operating signal for operating the at least one LED light source 12 is generated. Depending on the operating state ascertained in step 100, finally, in subsequent step 104 the operating frequency of the operating signal can be controlled, for example for minimizing the energy consumption and the heat generation of the LED light source 12. The method then continues again with step 100. If in a subsequent method step 100 a changed operating state of the motor vehicle is determined compared to a previous situation, the operating frequency of the operating signal of the LED light source 12 may be adapted in an appropriate manner in the repeated subsequent step 104.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A headlight arrangement for a motor vehicle, comprising:
a light source; and
a control device coupled to the light source that is configured to generate an operating signal pulsed over time for operating the light source,
wherein a frequency of the operating signal is regulated at least as a function of a momentary operating state of the motor vehicle.

2. The headlight arrangement according to claim 1, wherein the frequency of the operating signal is set within the a range of a flicker fusion frequency of a human eye.

3. The headlight arrangement according to claim 1, wherein the frequency of the operating signal is set to an operating frequency that is greater than A flicker fusion frequency by approximately 1%.

4. The headlight arrangement according to claim 1, wherein the frequency of the operating signal is set to an operating frequency that is less than a flicker fusion frequency by approximately 1%.

5. The headlight arrangement according to claim 1, wherein the frequency of the operating signal is controllable between approximately 15 Hz and approximately 90 Hz.

6. The headlight arrangement according to claim 1, wherein the function is a brightness of a vehicle environment.

7. The headlight arrangement according to claim 1, wherein the function is a vehicle speed.

8. The headlight arrangement according to claim 1, wherein the function is an energy reserves available to the motor vehicle.

9. The headlight arrangement according to claim 1, wherein the control device is configured to control the light source in a pulse-width-modulated manner.

10. The headlight arrangement according to claim 1, wherein the light source is a light-emitting diode (LED) light source.

11. (canceled)

12. A method for operating a headlight arrangement of a motor vehicle comprising a light source, comprising:
ascertaining a momentary operating state of the motor vehicle;
generating an operating signal to operate the light source; and
regulating a frequency of the operating signal as a function of the momentary operating state.

13. The method according to claim 12, wherein the frequency of the operating signal is set within a range of a flicker fusion frequency of a human eye.

14. A non-transitory computer readable medium embodying a computer program product, said computer program product comprising:
an operating program for operating a headlight arrangement of a vehicle that includes a light source, the operating program configured to:
ascertain a momentary operating state of the vehicle;
generate an operating signal for operating the light source; and
regulate a frequency of the operating signal as a function of the momentary operating state.

15. The headlight arrangement according to claim 1, wherein the frequency of the operating signal is set to an operating frequency that is greater than A flicker fusion frequency by approximately 20%.

16. The headlight arrangement according to claim 1, wherein the frequency of the operating signal is set to an operating frequency that is greater than A flicker fusion frequency by approximately 100%.

17. The headlight arrangement according to claim 1, wherein the frequency of the operating signal is set to an operating frequency that is less than a flicker fusion frequency by approximately 10%.

18. The headlight arrangement according to claim 1, wherein the frequency of the operating signal is set to an operating frequency that is less than a flicker fusion frequency by approximately 50%.

19. The headlight arrangement according to claim 1, wherein the light source is a front headlight.

20. The headlight arrangement according to claim 1, wherein the light source is a front fog light.

21. The headlight arrangement according to claim 1, wherein the light source is a daytime running light.
